(19) United States
(12) Patent Application Publication
(10) Pub. No.: US 2008/0069541 A1
(43) Pub. Date: Mar. 20, 2008

(54) Data recording apparatus, data recording method, and data recording program

(75) Inventors: Kenichiro Nagao, Tokyo (JP); Hiroki Shiina, Kanagawa (JP); Atsushi Mae, Kanagawa (JP); Tetsuhiro Maeda, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/888,917

(22) Filed: Aug. 2, 2007

(30) Foreign Application Priority Data
Aug. 11, 2006 (JP) P2006-220291

(51) Int. Cl. H04N 5/00

(52) U.S. Cl. 386/117

(57) ABSTRACT

A data recording apparatus may include a recording section for recording a plurality of record data onto a recording medium; a section for generating first playback existence/non-existence information of the record data, respectively, recorded on the recording medium; a section for generating first reference order information of the first playback existence/non-existence information; a section for generating second playback existence/non-existence information of the record data, respectively; a section for generating second reference order information of the second playback existence/non-existence information; and from the time that the record data has been recorded onto the recording medium to the time that common data management information among apparatuses is finally recorded onto the recording medium, a control section for controlling the recording section so as to record the first playback existence/non-existence information and the first reference-order definition information, and then to record the second playback existence/non-existence information and the second reference-order definition information.

### CROSS-REFERENCE TO RELATED APPLICATIONS

This application claims priority from Japanese Patent Application No. JP 2006-220291 filed in the Japanese Patent Office on Aug. 11, 2006, the entire content of which is incorporated herein by reference.

### BACKGROUND OF THE INVENTION

1. Field of the Invention

The present invention relates to a data recording apparatus, a data recording method, and a data recording program. For example, the present invention is preferably applied to a camera-integrated video recorder (in the following, referred to as a video camera) which records record data onto a rewritable optical disc.

2. Description of the Related Art

In a known video camera, when a moving image of an object is captured, recording data called a program stream generated by capturing the moving image of the object is recorded onto, for example a rewritable DVD-RW (Digital Versatile Disc-Rewritable) optical disc in conformity with a DVD (Digital Versatile Disc) video standard. After that, the optical disc is subjected to finalization processing, which finally records the common data management information among apparatuses onto an optical disc, to enable another apparatus to read the record data recorded on the optical disc. Also, in a video camera, in an intermediate state of an optical disc, which is a time period from the point in time when record data is recorded onto a new optical disc to the point in time when finalization processing is completed, when record data is recorded onto an optical disc in conformity with a DVD video standard, information on playback called intermediate-state management information has also been recorded. Thus, it has been possible for another playback apparatus to play back record data in accordance with the intermediate-state management information even before the completion of the finalization processing.

Here, as shown in FIG. 9, the logical format of an optical disc conforming to a DVD video standard includes a file-system recording area A1, a management-information recording area A2, and a data recording area A3.

In addition to these, an intermediate-state management information recording area B1 for effectively using an intermediate state of an optical disc is reserved between the management-information recording area A2 and the data recording area A3 so as not to violate the DVD video standard.

In the following, a description will be given of the contents to be recorded in the recording areas A1 to A3, and B1. First, in the data recording area A3, the record data RD called VTS VOBS (Video Title Set Video Objects), first playback existence/non-existence information L1 called VTSI (Video Title Set Information) indicating the playback existence/non-existence information of individual unit data called chapters a plurality of which constitutes the record data RD, and backup information (that is to say, the first playback existence/non-existence information L1) called VTSI BUP (Backup of VTSI) for backing up the first playback existence/non-existence information in the order of the first playback existence/non-existence information L1, the record data RD, and the first playback existence/non-existence information L1. In the data recording area A3, the first playback existence/non-existence information L1, which is generated in accordance with that record data RD recorded each time the record data RD is given, is recorded in the above-described order.

In the intermediate-state management information recording area B1, the information on playback (in the following, referred to as the first reference-order definition information) LC1, which defines the reference order of the first playback existence/non-existence information L1 recorded in the data recording area A3 in the intermediate state of the optical disc, is recorded. The first reference-order definition information LC1 is defined such that, for example the first playback existence/non-existence information L1 is referenced in the order of recording, and at the same time, the record data RD indicated by the referenced first playback existence/non-existence information L1 is read from the optical disc in sequence.

In the management-information recording area A2, the data management information DK, which is common among apparatuses, called VMGI (Video Management General Information) defining the reference order of the first playback existence/non-existence information L1 recorded in the data recording area A3 in the finalized state in which the finalization processing on the optical disc has been completed is recorded. The data management information DK is generated on the basis of the first reference-order definition information LC1. Also, in the management-information recording area A2, the playback-instruction screen display data MD, which is called VMGM (Video Management General Management Menu Video Objects) for displaying the playback instruction screen in accordance with the playlist defining the playback order of the record data RD formed by the first playback existence/non-existence information L1 and the data management information DK are recorded.

In the file-system recording area A1, the file-management information F conforming to a file system (in the following referred to as a UDF file system) called a UDF (Universal Disk Format) is recorded.

Thus, as shown in FIG. 10(A), when a known video camera captures a moving image of an object and records the generated record data RD onto an optical disc, at the time of receiving an input of a moving-image capturing instruction of the object, the video camera reserves the area (in the following, referred to as a first recording area) R1 for recording the file management information F on the data recording surface of the optical disc. Also, the video camera reserves the area (in the following, referred to as a second recording area) R2 for recording the data management information DK following the first recording area R1. Furthermore, the video camera reserves the area (in the following, referred to as a third recording area) R3 for recording the playback-instruction screen display data MD following the second recording area R2. Furthermore, the video camera reserves the area (in the following, referred to as a fourth recording area) R4 for recording the first reference-order definition information LC1 following the third recording area R3. Furthermore, the video camera reserves the area (in the following, referred to as a fifth recording area) R5 for recording the first playback existence/non-existence information L1 following the fourth recording area R4.

Next, as shown in FIG. 10(B), the video camera records the record data RD generated by capturing a moving image of the object onto a recording surface of the optical disc while reserving the first recording area R1, the second recording area R2, the third recording area R3, the fourth recording area R4, and the fifth recording area R5. As shown in FIG. 10(C), the video camera generates the first playback existence/non-existence information L1, records the information into the fifth recording area R5, and at the same time, records the first playback existence/non-existence information L1 again after the record data RD for a backup. Also, the video camera generates the first reference-order definition information LC1, and records this information into the reserved area R4.

As shown in FIG. 10(D), when the moving-image capturing instruction is input again, the video camera reserves the fifth recording area R5, and then additionally records the record data RD generated by capturing the moving image of the object. Also, the video camera generates the first playback existence/non-existence information L1 corresponding to the added record data RD, and additionally records the information into the fifth recording area R5. At the same time, the video camera additionally records the first playback existence/non-existence information L1 after the record data RD for a backup. At this time, the video camera updates the first reference-order definition information LC1 so as to reference the second piece of the first playback existence/non-existence information L1 that was added following the first piece of the first reference-order definition information LC1 that was already recorded. In this manner, each time the video camera additionally records the record data RD onto the data recording surface of the optical disc, the video camera generates and additionally records the first playback existence/non-existence information L1 corresponding to that record data RD, and updates the first reference-order definition information LC1 so as to reference the additionally recorded first playback existence/non-existence information L1.

Next, as shown in FIG. 10(E), when a finalization processing instruction for performing the finalization processing on the disc is input, the video camera generates the file management information F, and records the information into the first recording area R1. Also, the video camera generates the data management information DK on the basis of the first reference-order definition information LC1, and records the information into the second recording area R2. Furthermore, the video camera generates the playback-instruction screen display data MD, and records the data into the third recording area R3.

In this manner, a known video camera records the record data RD generated by capturing a moving image of an object onto a recording surface of an optical disc in conformity with a DVD video standard, and executes the finalization processing to complete the processing. When the video camera reads the record data from the optical disc, and plays back the data, the video camera plays back the record data RD in accordance with the playback order indicated by the first playback existence/non-existence information L1 and the data management information DK (for example, refer to Japanese Unexamined Patent Application Publication No. 2003-331526).

### SUMMARY OF THE INVENTION

Incidentally, in such a video camera, when record data RD is read from an optical disc and played back, there is only one kind of playback order of the record data RD, which is indicated by the first playback existence/non-existence information L1 and the data management information DK. Thus, when the record data RD is played back in another playback order, all the record data RD recorded on the recording surface of the optical disc is read by another playback apparatus, etc., the playback order is edited, and the record data RD is recorded again in accordance with the edited playback order. Accordingly, there has been a problem in the video camera in that the edit processing of the playback order of a plurality of record data is troublesome.

The present invention has been made in view of the above points. It is desirable to provide a data recording apparatus, a data recording method, and a data recording program capable of reducing time and effort of the edit processing of the playback order of a plurality of record data.

According to an embodiment of the present invention, there is provided a data recording apparatus which may include a recording section for recording a plurality of record data onto a recording medium; a first playback existence/non-existence information generation section for generating a plurality of pieces of first playback existence/non-existence information indicating playback existence/non-existence of a plurality of the record data, respectively, recorded on the recording medium by the recording section; a first reference-order definition information generation section for generating first reference-order definition information defining reference order of a plurality of pieces of the first playback existence/non-existence information; a second playback existence/non-existence information generation section for generating a plurality of pieces of second playback existence/non-existence information indicating playback existence/non-existence of a plurality of the record data, respectively, recorded on the recording medium by the recording section; a second reference-order definition information generation section for generating second reference-order definition information defining reference order of a plurality of pieces of the second playback existence/non-existence information; and from the time that the record data has been recorded onto the recording medium to the time that common data management information among apparatuses is finally recorded onto the recording medium in order to allow another data-playback apparatus to play back the record data from the recording medium, a control section for controlling the recording section so as to record a plurality of pieces of the first playback existence/non-existence information and the first reference-order definition information, and then to record a plurality of pieces of the second playback existence/non-existence information and the second reference-order definition information.

Accordingly, in the present invention, when a plurality of record data are recorded onto a recording medium, a plurality of pieces of first playback existence/non-existence information indicating the playback existence/non-existence of a plurality of the record data, respectively, recorded on the recording medium may be generated, and first reference-order definition information defining reference order of a plurality of pieces of the first playback existence/non-existence information may be generated. At the same time, a plurality of pieces of second playback existence/non-existence information indicating the playback existence/non-existence of a plurality of the record data, respectively, recorded on the recording medium by the recording section may be generated, and second reference-order definition information defining reference order of a plurality of pieces of the second playback existence/non-existence information may be generated. From the time that the record data has been recorded onto the recording medium to the time that common data management information among apparatuses is finally recorded onto the recording medium, in order to allow another data-playback apparatus to play back the record data from the recording medium, control may be performed such that a plurality of pieces of the first playback existence/non-existence information and the first reference-order definition information are recorded, and then a plurality of pieces of the second playback existence/non-existence information and the second reference-order definition information are recorded. Thus, when the playback order of a plurality of the record data is edited, it may be possible to edit the playback order of the record data only by generating and recording a plurality of the second playback existence/non-existence information and the second reference-order definition information.

By the present invention, when a plurality of record data is recorded onto a recording medium, a plurality of pieces of first playback existence/non-existence information indicating the playback existence/non-existence of a plurality of the record data, respectively, recorded on the recording medium may be generated, and first reference-order definition information defining reference order of a plurality of pieces of the first playback existence/non-existence information may be generated. At the same time, a plurality of pieces of second playback existence/non-existence information indicating the playback existence/non-existence of a plurality of the record data, respectively, recorded on the recording medium by the recording section may be generated, and second reference-order definition information defining the reference order of a plurality of pieces of the second playback existence/non-existence information may be generated. From the time that the record data has been recorded onto the recording medium to the time that common data management information among apparatuses is finally recorded onto the recording medium, in order to allow another data-playback apparatus to play back the record data from the recording medium, control may be performed such that a plurality of pieces of the first playback existence/non-existence information and the first reference-order definition information are recorded, and then a plurality of pieces of the second playback existence/non-existence information and the second reference-order definition information are recorded. Thus, when the playback order of a plurality of record data is edited, it may be possible to edit the playback order to the record data only by generating and recording a plurality of the second playback existence/non-existence information and the second reference-order definition information. In this manner, it is possible to provide a data recording apparatus, a data recording method, and a data recording program capable of reducing time and effort of the edit processing of the playback order of a plurality of record data.

### BRIEF DESCRIPTION OF THE DRAWINGS

FIG. 1 is a block diagram illustrating the circuit configuration of a video camera according to an embodiment of the present invention;

FIG. 2 is a schematic diagram illustrating a state of recording record data;

FIG. 3 is a schematic diagram illustrating the configuration of a PGC;

FIG. 4 is a flowchart illustrating playback-order edit processing procedure;

FIG. 5 is a schematic diagram used for illustrating playback order of record data;

FIGS. 6A and 6B are schematic diagrams used for explaining a playback instruction screen (1);

FIGS. 7A, 7B, and 7C are schematic diagrams used for explaining a playback instruction screen (2);

FIG. 8 is a flowchart illustrating a finalization processing procedure;

FIG. 9 is a schematic diagram illustrating a state of recording record data by a DVD video standard; and

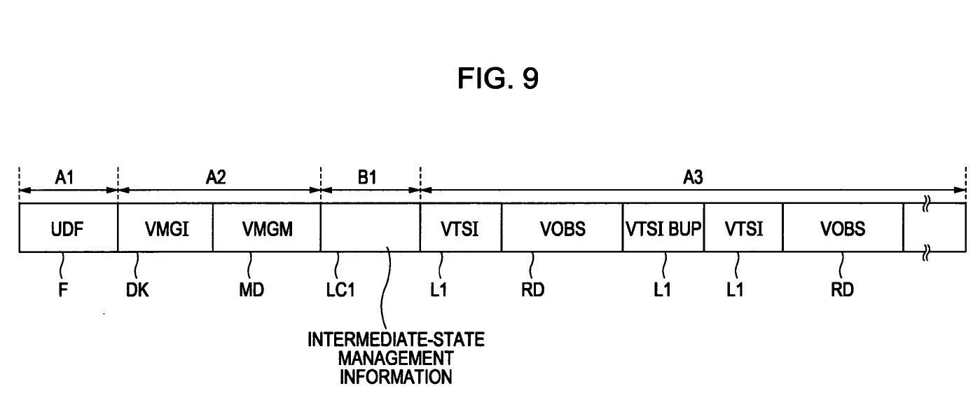

FIG. 10 is a schematic diagram illustrating a state of recording known record data.

### DETAILED DESCRIPTION

In the following a detailed description will be given of an embodiment of the present invention with reference to the drawings.

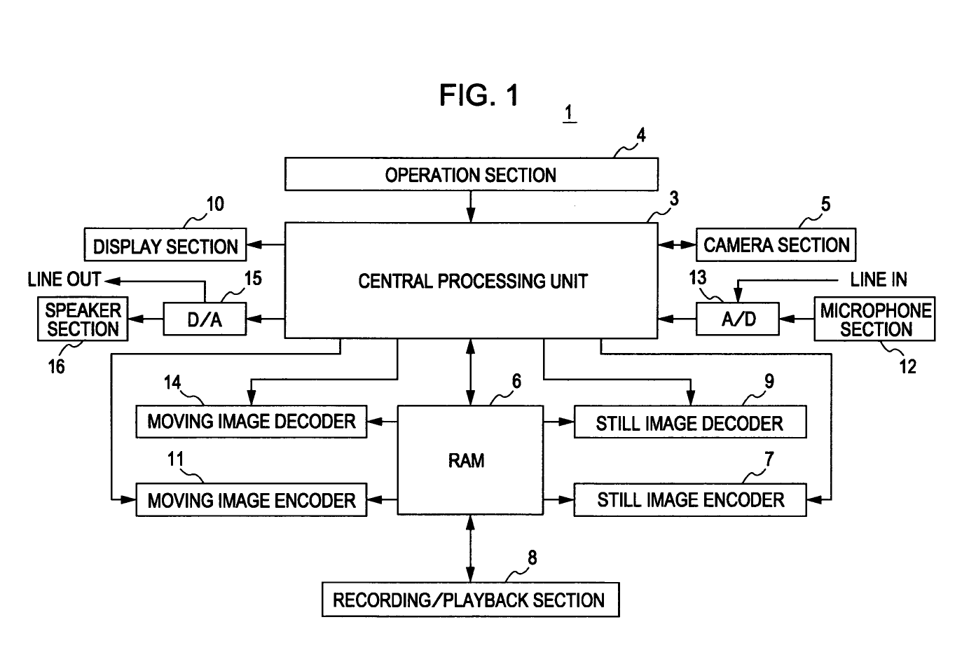

Referring to FIG. 1, reference numeral 1 denotes a general block diagram illustrating the configuration of a video camera to which the present invention is applied. In the video camera 1, a central processing unit 3 reads and executes the various programs stored in a memory not shown in the figure in advance in a state in which an optical disc not shown in the figure, such as a rewritable DVD-RW, for example is loaded into the main unit, and executes various processing by totally controlling the entire video camera 1. Also, a still image encoder 7, a still image decoder 9, a moving image encoder 11, a moving image decoder 14, and a recording/playback section 8 are connected to the central processing unit 3 through a RAM (Random Access Memory) 6 including a SD-RAM (Synchronous Dynamic-Random Access Memory), etc. The central processing unit 3, the still image encoder 7, the still image decoder 9, the moving image encoder 11, the moving image decoder 14 and the recording/playback section 8 use the RAM 6 as a work area.

By this means, at the time of still-image recording processing for taking a picture of an object and recording the photographic still-image data, when a shooting instruction for taking a picture of the object is input from the operation section 4 in response to the operation on a touch panel or an operation key not shown in the figure of an operation section 4, the central processing unit 3 performs compression coding on the still image data generated by the camera section 5 taking a picture of the object in accordance with a compression coding method, for example JPEG (Joint Photographic Experts Group) using the still image encoder 7 to generate the still-image coded data, and sends the generated still-image coded data to the recording/playback section 8. The recording/playback section 8 records the still-image coded data onto an optical disc loaded in the main unit.

On the other hand, at the time of still-image playback processing for performing the playback processing on the still-image data, when a playback instruction for playing back the still-image data is input from the operation section 4 in response to the operation on the operation section 4, the central processing unit 3 decodes the still-image coded data read from the optical disc by the recording/playback section 8 using the still image decoder 9, and displays the still image based on the generated still image data onto the display section 10.

Also, at the time of moving-image recording processing, when a moving-image capturing instruction for recording the moving image data by capturing the moving image of the object is input from the operation section 4 in response to the operation on the operation section 4, the central processing unit 3 performs compression coding for each predetermined unit on the moving image data generated by the camera section 5 capturing the moving image of the object in accordance with a compression coding method, for example MPEG-2 (Moving Picture Experts Group phase 2) using the moving image encoder 11 to generate a moving-image stream. Also, the central processing unit 3 performs compression coding for each predetermined unit on the sound data obtained by performing analog-to-digital conversion on the audio signal obtained by collecting the sound around the object by a microphone section 12 using an A/D (Analog to Digital) converter circuit 13 in parallel with capturing the moving image of the object by the camera section 5 in accordance with MPEG-2 using the moving image encoder 11 to generate a sound stream. The central processing unit 3 performs time-division multiplexing on the moving image stream and the sound stream to generate the record data RD, and at the same time, sends the generated record data RD to the recording/playback section 8. In this regard, at the time of moving-image recording processing, in place of generating a sound signal by the microphone section 12, the central processing unit 3 can take in a sound signal, such as BGM (Back Ground Music) from the outside through the A/D converter circuit 13, and can perform compression coding on the sound data using the moving image encoder 11.

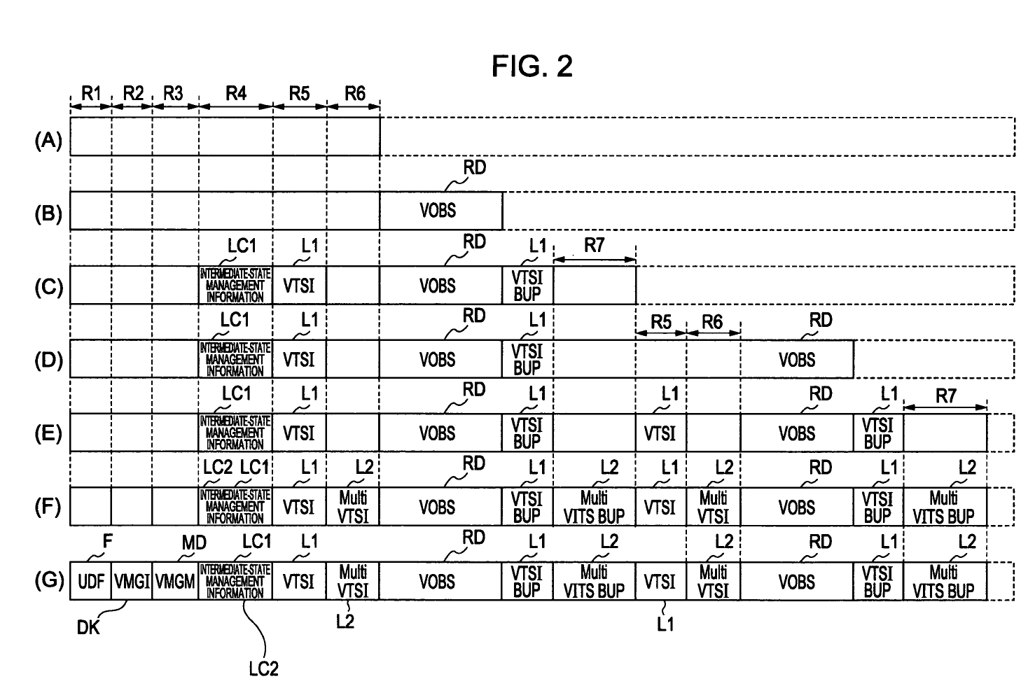

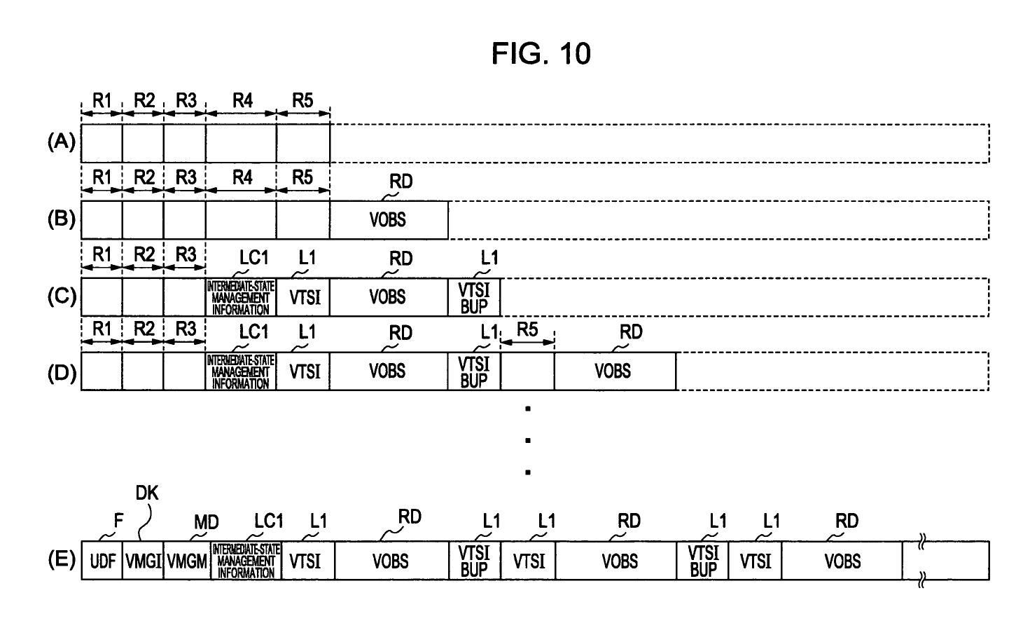

As shown in FIG. 2, in which the corresponding parts to those in FIG. 10 are marked with the same reference letters and numerals, at the time of the recording processing of a moving image, the central processing unit 3 records the record data RD onto an optical disc by the recording/playback section 8. As shown in FIG. 2(A), at the time of the recording processing of the moving image, when a moving-image capturing instruction of an object is input, using the recording/playback section 8, the central processing unit 3 reserves a first recording area R1 for recording the file management information F. Also, the central processing unit 3 reserves a second recording area R2 for recording the data management information DK, a third recording area R3 for recording the playback-instruction screen display data MD, a fourth recording area R4 for recording the first reference-order definition information LC1, and a fifth recording area R5 for recording the first playback existence/non-existence information L1.

In addition to this, the central processing unit 3 reserves, using the recording/playback section 8, the area (in the following, referred to as a sixth recording area) R6 for recording the second playback existence/non-existence information L2 individually indicating the playback existence/non-existence information of a plurality of unit data constituting the record data RD.

Next, as shown in FIG. 2(B), the central processing unit 3 records the record data RD onto the recording surface of the optical disc using the recording/playback section 8 with the first recording area R1, the second recording area R2, the third recording area R3, the fourth recording area R4, the fifth recording area R5, and the sixth recording area R6 reserved. As shown in FIG. 2(C), the central processing unit 3 generates the first playback existence/non-existence information L1 and records this information into the fifth recording area R5 using the recording/playback section 8, and at the same time, records again the first playback existence/non-existence information L1 after the record data RD for a backup. Also, the central processing unit 3 generates the first reference-order definition information LC1, and records this information into the fourth recording area R4 using the recording/playback section 8.

In addition to this, using the recording/playback section 8, the central processing unit 3 reserves an area (in the following, referred to as a seventh recording area) R7 for recording the second playback existence/non-existence information L2 for a backup.

As shown in FIG. 2(D), when the moving-image capturing instruction is input again, using the recording/playback section 8, the central processing unit 3 reserves the fifth recording area R5 and the sixth recording area R6, and then additionally records the record data RD generated by capturing a moving image of the object. Also, as shown in FIG. 2(E), the central processing unit 3 generates the first playback existence/non-existence information L1 corresponding to the added record data RD, and additionally records the information into the fifth recording area R5, and additionally records again the first playback existence/non-existence information L1 after the record data RD using the recording/playback section 8. After that, the central processing unit 3 reserves the seventh recording area R7 again. At this time, the central processing unit 3 updates the first reference-order definition information LC1 such that the second piece of the first playback existence/non-existence information L1 added is also referenced following the first piece of the first playback existence/non-existence information L1 already recorded.

In this manner, each time the central processing unit 3 additionally records the record data RD onto the data recording surface of the optical disc, the central processing unit 3 generates and additionally records the first playback existence/non-existence information L1 corresponding to that record data RD, and updates the first reference-order definition information LC1 so as to reference the additionally recorded first playback existence/non-existence information L1. At the same time, the central processing unit 3 reserves the sixth recording area R6 and the seventh recording area R7 for recording the second playback existence/non-existence information L2 generated in the playback-order edit information described below in advance.

In an intermediate state of the optical disc, when a playback-order edit instruction for editing the playback order of the record data RD is input from the operation section 4 in response to the operation on the operation section 4, the central processing unit 3 starts playback-order edit processing for editing the playback order of the record data RD recorded on the optical disc. At the time of such playback-order edit processing, the central processing unit 3 reads the first reference-order definition information LC1 and all the first playback existence/non-existence information L1 using the recording/playback section 8.

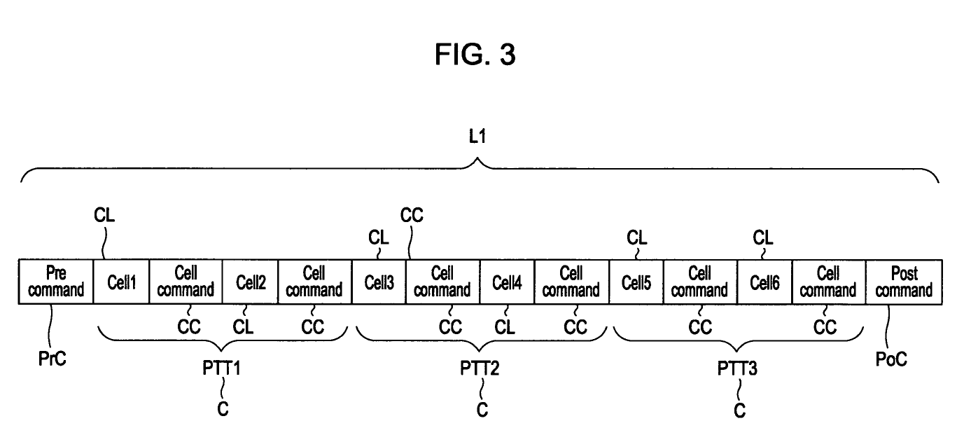

As shown in FIG. 3, the first playback existence/non-existence information L1 is also called a PGC (Program Chain), and includes one or a plurality of pieces of unit-data playback specification information C, which is called a PTT (Part of Title) or a chapter, playback-time specification information PrC, which is called a pre-command, and post-playback specification information PoC, which is called a post-command.

The unit-data playback specification information C includes a plurality of pieces of continuous information (in the following, referred to as unit-layback specification information) CL called a cell, which specifies the record data RD for each predetermined unit for the playback of the record data RD recorded on the recording surface of the optical disc for each predetermined unit. The unit-data playback specification information C is a plurality of pieces of continuous information specifying the record data RD (in the following, referred to as unit data) for each predetermined unit, which is specified by the plurality of the unit-playback specification information CL, collectively for playback. The playback existence/non-existence information of this unit-data playback specification information C is defined by the first playback existence/non-existence information L1. Also, in the unit-playback specification information CL, the information (in the following referred to as reference destination information) CC, called a cell command, indicating the next reference destination (in this case, another unit-data playback specification information C and the first reference-order definition information LC1) can be described. If nothing is described, the next unit-playback specification information CL is to be processed succeedingly.

The playback-time specification information PrC describes the information for identifying the first playback existence/non-existence information L1 and the information for referencing the unit-data playback specification information C to start the playback. The post-playback specification information PoC can describe an instruction to be executed after the playback of the unit data referenced by each unit-data reference information C, and in general, describes the next reference destination in the same manner as the reference destination information CC.

By this means, at the time of playback-order edit processing, the central processing unit 3 refers to the first playback existence/non-existence information L1 sequentially in accordance with the order defined in the first reference-order definition information LC1, and sequentially identifies the unit data of the record data RD specified in the unit-data reference information C of the first playback existence/non-existence information L1 every time the first playback existence/non-existence information L1 is referenced. The central processing unit 3 reads, for example the beginning frame image data (in the following, referred to as the beginning frame image data) out of a plurality of the frame image data constituting the identified unit data, displays frame images based on the read frame image data onto the display section 10 in sequence, and thus presents the playback order for each unit data of the record data RD recorded on the optical disc at the present time. In reality, a plurality of pieces of the first playback existence/non-existence information L1 and the first reference-order definition information LC1 generated in accordance with the recorded order of the record data RD are recorded onto the optical disc. Thus, the central processing unit 3 presents the playback order (in the following, referred to as an original playback order) in accordance with the recorded order of record data RD to the user.

When a playback order is edited for each unit data of the record data RD from the operation section 4 in response to the operation on the operation section 4, the central processing unit 3 generates the second playback existence/non-existence information L2 corresponding to the edited playback order (in the following, referred to as an edit playback order) for each record data RD. As shown in FIG. 2(F), the central processing unit 3 records the second playback existence/non-existence information L2 into the sixth record are R6 corresponding to the record data RD, respectively, using the recording/playback section 8, and records again the second playback existence/non-existence information L2 into the seventh record are R7 corresponding to the record data RD, respectively, for a backup. Also, the central processing unit 3 generates the second reference-order definition information LC2 defining the reference order of the second playback existence/non-existence information L2. The central processing unit 3 additionally records, using the recording/playback section 8, the second reference-order definition information LC2 in the area (that is to say, the fourth recording area R4) in which the first reference-order definition information LC1 is recorded. That is to say, the central processing unit 3 generates the second playback existence/non-existence information L2 according to the edit playback order as the edit result of the playback order of the record data RD and the second reference-order definition information LC2, and records this onto the optical disc using the recording/playback section 8 to terminate the playback-order edit processing. Incidentally, the central processing unit 3 executes the playback-order edit processing every time the playback-order edit instruction is input, and newly generates a plurality of the second playback existence/non-existence information L2 according to the edit playback order, and the second reference-order definition information LC2. The central processing unit 3 additionally records, using the recording/playback section 8, the newly generated second playback existence/non-existence information L2 into the corresponding sixth record area R6 and the seventh record area R7 each time, and additionally records the newly generated second reference-order definition information LC2 into the fourth recording area R4 each time.

At this time, a plurality of pieces of the second playback existence/non-existence information L2 according to the edit playback order and the second reference-order definition information LC2 are recorded on the optical disc, and a plurality of pieces of the first playback existence/non-existence information L1 according to the original playback order and the first reference-order definition information LC1 are recorded without change. Thus, when the central processing unit 3 plays back the optical disc after the playback-order edit processing, the central processing unit 3 can play back the record data RD in the original playback order in accordance with the first playback existence/non-existence information L1 and the first reference-order definition information LC1. At the same time, the central processing unit 3 can play back the record data RD in the edited playback order in accordance with the second playback existence/non-existence information L2 and the second reference-order definition information LC2. When another playback apparatus plays back this optical disc, the playback can be carried out in the original playback order in accordance with the first playback existence/non-existence information L1 and the first reference-order definition information LC1, and thus playback compatibility of the optical disc in an intermediate state is maintained.

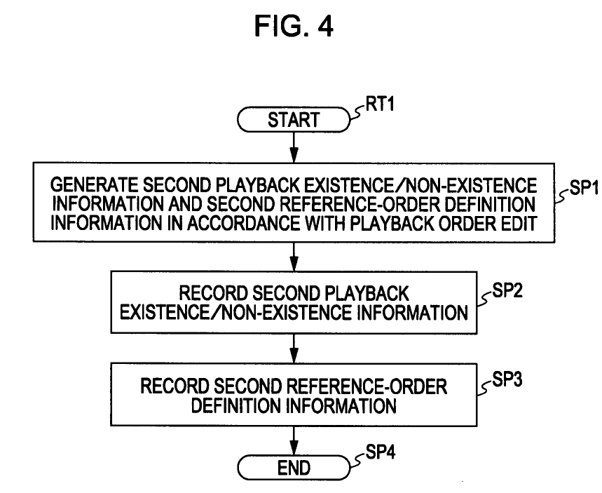

Here, in an intermediate state of the optical disc, when a playback-order edit instruction is input, the video camera 1 starts the playback-order edit processing RT1, as shown in FIG. 4, for editing the playback order of the record data RD recorded on the optical disc. When such playback-order edit processing RT1 is started, in step SP1, the central processing unit 3 generates the second playback existence/non-existence information L2 and the second reference-order definition information LC2 in accordance with the edit of the playback order for each unit data of the record data RD, and the processing proceeds to the next step SP2.

In step SP2, the central processing unit 3 records the second playback existence/non-existence information L2 onto the optical disc, and the processing proceeds to the next step SP3.

In step SP3, the central processing unit 3 records the second reference-order definition information LC2 onto the optical disc, the processing proceeds to the next step SP4, and terminates the playback-order edit processing RT1.

By such playback-order edit processing RT1, the video camera 1 edits the playback order of the record data RD recorded on the optical disc.

In addition to this, when a finalization processing instruction, which finally records the common data management information among apparatuses onto the optical disc, is input from the operation section 4 in response to the operation on the operation section 4, the central processing unit 3 starts the finalization processing for finally recording the common data management information among apparatuses onto the optical disc.

At the time of such finalization processing, the central processing unit 3 reads all the first playback existence/non-existence information L1 from the optical disc using the recording/playback section 8, and additionally records this as the second playback existence/non-existence information L2 into the corresponding sixth recording area R6 and seventh recording area R7. The central processing unit 3 generates the second reference-order definition information LC2 in accordance with a plurality of the added second playback existence/non-existence information L2, and additionally records this into the fourth recording area R4 using the recording/playback section 8. Thus, the central processing unit 3 sets the original playback order defined by a plurality of the first playback existence/non-existence information L1 and the first reference-order definition information LC1 as one of the edit playback order defined by the second playback existence/non-existence information L2 and the second reference-order definition information LC2.

Next, the central processing unit 3 reads all the second reference-order definition information LC2 from the fourth recording area R4 of the optical disc using the recording/playback section 8, and generates the data management information DK on the basis of all the read second reference-order definition information LC2. The central processing unit 3 records the data management information DK into the second recording area R2 of the optical disc using the recording/playback section 8. That is to say, in a finalization state of the optical disc, the central processing unit 3 generates the data management information DK capable of defining the reference order of the second playback existence/non-existence information L2, and records the generated data management information DK onto the optical disc using the recording/playback section 8.

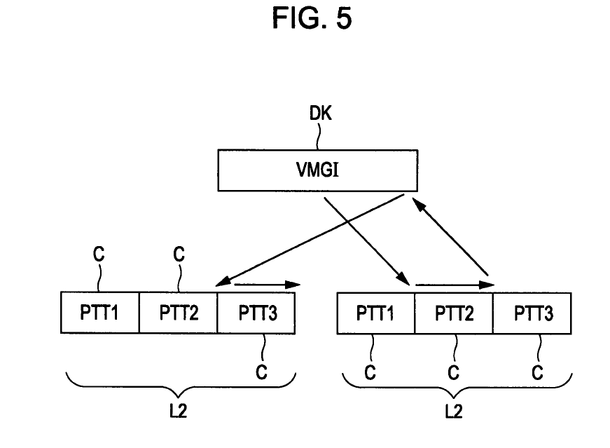

Here, the central processing unit 3 reads, from the optical disc using the recording/playback section 8, data management information DK, the original playback order, and all the second playback existence/non-existence information L2 individually corresponding to a plurality of edit playback orders. As shown in FIG. 5, the central processing unit 3 refers to the second playback existence/non-existence information L2 defined in the data management information DK in sequence, and individually identifies the original playback order and a plurality of edit playback order of the record data RD by referencing the unit-data reference information C specified in the second playback existence/non-existence information L2. Thus, the central processing unit 3 individually forms the playlist (in the following, referred to as an original playlist) for playing back the record data RD in accordance with the identified original playback order, and a plurality of playlists (in the following, referred to as edit playlists) for playing back the record data RD in accordance with the identified plurality of edit playback orders. As shown in FIG. 2(G), the central processing unit 3 generates the playback-instruction screen display data MD for displaying a plurality of playback instruction screens individually corresponding to the original playlist and a plurality of edit playlists, and records the generated playback-instruction screen display data MD into the third recording area R3 using the recording/playback section 8.

Also, the central processing unit 3 generates the file management information F conforming to a UDF file system, and records the generated file management information F in the first recording area R1 using the recording/playback section 8. The central processing unit 3 performs, on the optical disc, the processing called border close which records predetermined data indicating that the optical disc is prohibited to be written hereafter.

In this manner, the central processing unit 3 finally records the common data management information DK among the other apparatuses on the optical disc, and terminates the finalization processing.

At the time of the moving-image playback processing, which reads and plays back the record data RD from the finalized state of the optical disc, when a moving-image playback instruction for playing back the record data RD is input from the operation section 4 in response to the operation on the operation section 4, the central processing unit 3 reads the playback-instruction screen display data MD from the optical disc using the recording/playback section 8. Also, the central processing unit 3 displays the playback instruction screen based on the read playback-instruction screen display data MD onto the display section 10, thereby presenting the corresponding playback orders to the user in the original playlist and a plurality of edit playlists.

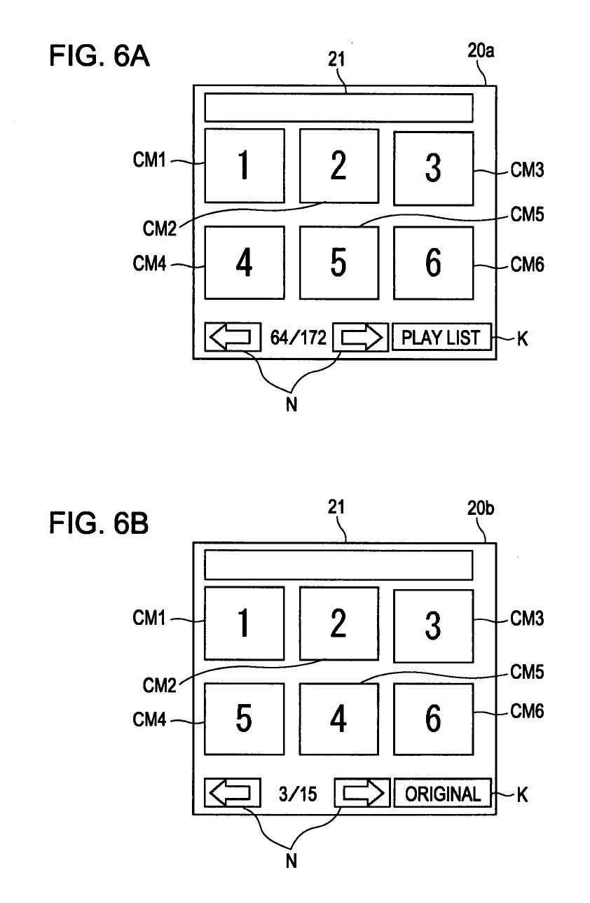

In reality, as shown in FIG. 6A, the central processing unit 3 displays, for example a playback instruction screen (in the following, referred to as an original playback instruction screen) 20a corresponding to an original playlist onto the display section 10. On the original playback instruction screen 20a, a plurality of beginning frame images (in the following, referred to as chapter selection images) CM for selecting unit data for playback, based on the beginning frame image data of a plurality of unit data, which are identified in sequence by the data management information DK and the second playback existence/non-existence information L2 corresponding to the original playback order are displayed. Also, in the lower part of the original playback instruction screen 20a, a page selection button N is displayed. When a plurality of chapter selection images CM corresponding to the selected playback order (in this case, original playback order) are not allowed to be displayed on one original playback instruction screen 20a, another original playback instruction screen 20a for displaying the remaining chapter selection images can be selected as another page.

Also, the display section 10 is a touch panel capable of entering a predetermined instruction by touching the display screen. Each location of the touch panel is related to a chapter selection image CM, the page selection button N or the like of the original playback instruction screen 20a.

By this means, the central processing unit 3 makes the user select a desired chapter selection image CM using the touch panel of the operation section 4 corresponding to the page selection button N and a plurality of the chapter selection images CM of the original playback instruction screen 20a displayed on the display section 10.

Also, an information display window 21, which can display, for example the playback instruction screen displayed in the display section 10 at the present time is the original playback instruction screen 20a by displaying the character string “Original”, is displayed in the upper part of the original playback instruction screen 20a. Furthermore, a playback-instruction screen change button K, which changes in both ways between the original playback instruction screen 20a displayed in the display section 10 at the present time and the playback instruction screen (in the following, referred to as an edit-playback instruction screen) 20b according to the edit playlist, is displayed in the lower part of the original playback instruction screen 20a.

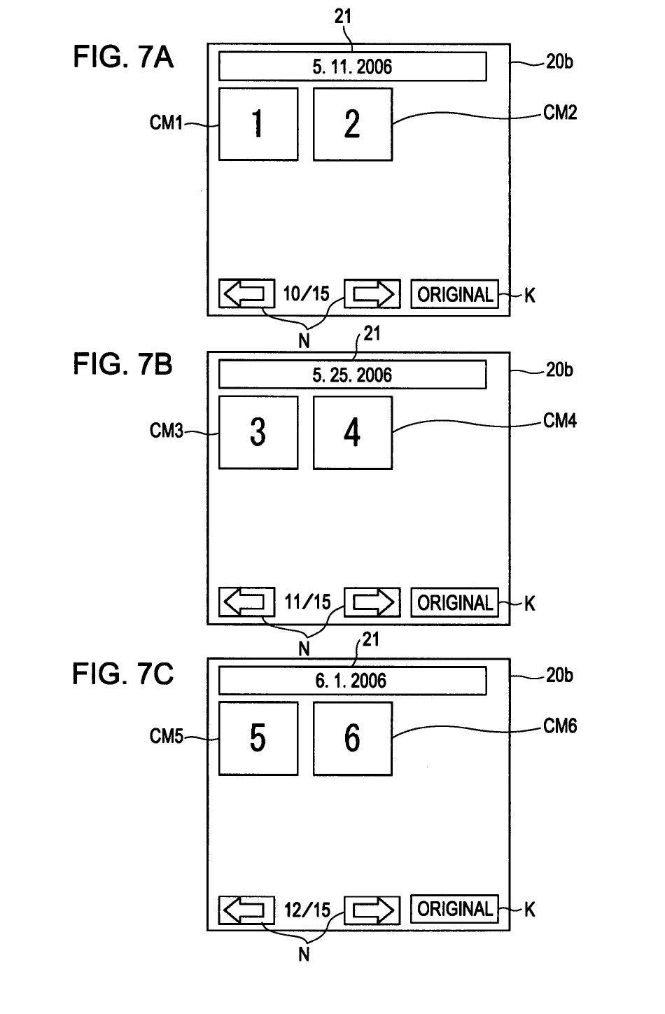

By this means, as shown in Fig. B, when the playback-instruction screen change button K of the original playback instruction screen 20a displayed on the display section 10 is selected, the central processing unit 3 displays the edit-playback instruction screen 20b onto the display section 10 in place of the original playback instruction screen 20a. As shown in FIG. 7, in the edit-playback instruction screen 20b, when the playback order is edited, for example in accordance with the date and time when moving images of objects are captured, chapter selection images CM corresponding to the unit data of the record data RD recorded at the data and time when the moving images of objects are captured are displayed.

In this manner, the central processing unit 3 displays the original playback instruction screen 20a and the edit-playback instruction screen 20b onto the display section 10, and makes the user select a chapter selection image CM to play back. When a predetermined chapter selection image CM is selected from the operation section 4 in response to the operation on the touch panel of the operation section 4, the central processing unit 3 reads the record data RD for each unit data corresponding to the selected chapter selection image CM from the optical disc using the recording/playback section 8.

Next, the central processing unit 3 separates the moving image stream and the sound stream from the read record data RD. The central processing unit 3 sends the moving image stream and the sound stream to the moving image decoder 14. The moving image decoder 14 decodes the moving image stream to generate the moving image data, and sends the generated moving image data to the central processing unit 3. Also, the moving image decoder 14 decodes the sound stream to generate the sound data, and sends the generated sound data to the central processing unit 3. The central processing unit 3 sends the moving image data to the display section 10 to display the moving image based on the moving image data. Also, the central processing unit 3 performs digital-analog conversion on the sound data using a D/A (Digital to Analog) converter circuit 15 to send the data to a speaker section 16. Thereby, the central processing unit 3 outputs the sound based on the sound data from the speaker section 16 in synchronism with the display of the moving image on the display section 10. In this regard, the central processing unit 3 may send the sound data VD from the D/A converter circuit 15 to an external headphone, etc., in place of the speaker section 16, thereby outputting the sound from the external headphone, etc., instead of outputting the sound from the speaker section 16.

In this manner, the central processing unit 3 reads the record data RD from the optical disc, and plays back the read record data RD.

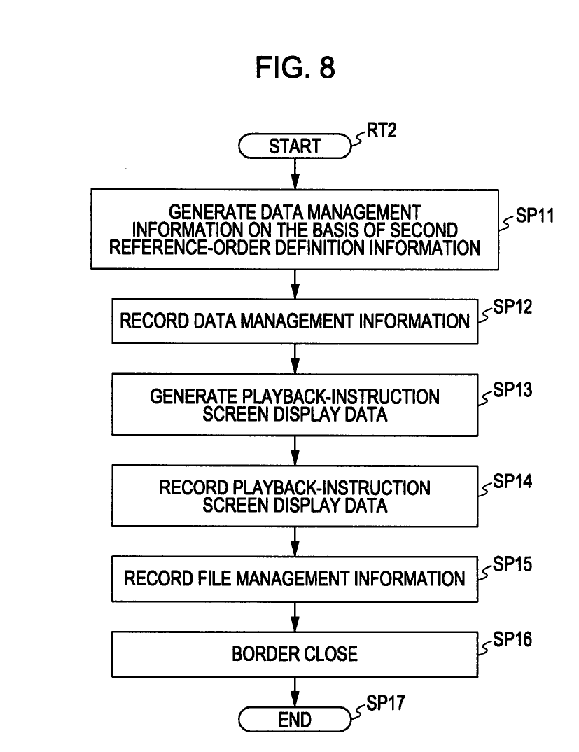

Here, in an intermediate state of the optical disc, when a finalization processing instruction is input, the video camera 1 starts the finalization processing procedure RT2, as shown in FIG. 8, for finally recording the common data management information DK among the other apparatuses onto the optical disc. When the central processing unit 3 starts the finalization processing procedure RT2, in step SP11, the central processing unit 3 generates the data management information DK on the basis of the second reference-order definition information LC2, and the processing proceeds to the next step SP12.

In step SP12, the central processing unit 3 records the data management information DK onto the optical disc using the recording/playback section 8, and the processing proceeds to the next step SP13.

In step SP13, the central processing unit 3 forms the playlist corresponding to the playback order defined by the second reference-order definition information LC2 and the second playback existence/non-existence information L2, generates the playback-instruction screen display data MD according to the playlist, and the processing proceeds to the next step SP14.

In step SP14, the central processing unit 3 records the playback-instruction screen display data MD onto the optical disc using the recording/playback section 8, and the processing proceeds to the next step SP15.

In step SP15, the central processing unit 3 generates the file management information F conforming to a UDF file system, records this onto the optical disc using the recording/playback section 8, and the processing proceeds to the next step SP16.

In step SP16, the central processing unit 3 records, on the optical disc, predetermined data indicating that the optical disc is prohibited to be written hereafter. The processing proceeds to step SP17, and the central processing unit 3 terminates the finalization processing procedure RT2.

By such finalization processing procedure RT2, the video camera 1 finally records the data management information DK common to the other apparatuses.

In the above configuration, when the video camera 1 records the record data RD generated by capturing a moving image of an object onto an optical disc, the video camera 1 reserves the sixth recording area R6 and the seventh recording area R7 for recording a plurality of the second playback existence/non-existence information L2 in advance, and records the record data RD, a plurality of the first playback existence/non-existence information L1 according to the original playback order of the record data RD, and the first reference-order definition information LC1 onto the optical disc. In the intermediate state of the optical disc, when the playback order of the record data RD for each unit data is edited, the video camera 1 generates a plurality of the second playback existence/non-existence information L2 corresponding to the edited edit playback order, records this into the sixth recording area R6 and the seventh recording area R7, and generates the second reference-order definition information LC2 defining the reference order of the plurality of the second playback existence/non-existence information L2, and additionally records this into the fourth recording area R4 in which the first reference-order definition information LC1 is recorded.

Accordingly, when the video camera 1 edits the playback order of the record data RD, since the sixth recording area R6 and the seventh recording area R7 for recording the second playback existence/non-existence information L2 are reserved in advance, the video camera 1 can edit the playback order of the record data RD only by recording a plurality of the second playback existence/non-existence information L2 generated in accordance with the edit playback order and the second reference-order definition information LC2 onto the optical disc.

Also, When editing the playback order to the record data RD for each unit data, the video camera 1 keeps a plurality of the first playback existence/non-existence information L1 according to the original playback order of the record data RD, and the first reference-order definition information LC1, and records a plurality of the second playback existence/non-existence information L2 generated corresponding to the edit playback order and the second reference-order definition information LC2 onto the optical disc. Thus, it is possible to keep a plurality of the first playback existence/non-existence information L1 and the first reference-order definition information LC1, which are necessary when another playback apparatus plays back an optical disc in an intermediate state. As a result, it is possible to keep the playback compatibility of the optical disc in the intermediate state between another playback apparatus.

With the above configuration, when the video camera 1 records a plurality of record data RD onto an optical disc, the video camera 1 generates a plurality of pieces of first playback existence/non-existence information L1 indicating the playback existence/non-existence of a plurality of the record data RD, respectively, recorded on the optical disc, and the first reference-order definition information LC1 defining reference order of a plurality of pieces of the first playback existence/non-existence information L1. At the same time, the video camera 1 generates a plurality of pieces of second playback existence/non-existence information L2 indicating playback existence/non-existence of a plurality of the record data RD, respectively, recorded on the optical disc by the recording/playback section 8, and the second reference-order definition information LC2 defining the reference order of a plurality of pieces of the second playback existence/non-existence information L2. From the time that the record data RD has been recorded onto the optical disc to the time that common data management information DK among apparatuses is finally recorded onto the optical disc, in order to allow another data-playback apparatus to play back the record data RD from the optical disc, control is performed such that a plurality of pieces of the first playback existence/non-existence information L1 and the first reference-order definition information LC1 are recorded, and then a plurality of pieces of the second playback existence/non-existence information L2 and the second reference-order definition information LC2 are recorded. Thus, when the video camera 1 edits the playback order of a plurality of record data RD, the video camera 1 can edit the playback order of the record data only by generating and recording a plurality of the second playback existence/non-existence information L2 and the second reference-order definition information LC2. Accordingly, it is possible to reduce time and effort for the edit processing of the playback order of a plurality of record data.

Also, in a state in which a plurality of the sixth recording areas R6 and the seventh recording areas R7 for recording a plurality of the second playback existence/non-existence information L2 are reserved on the optical disc, the video camera 1 records a plurality of record data RD, a plurality of first playback existence/non-existence information L1, the first reference-order definition information LC1, and then records a plurality of the second playback existence/non-existence information L2 into a plurality of the sixth recording areas R6 and the seventh recording areas R7. By this means, when the video camera 1 edits the playback order of a plurality of the record data RD, and records a plurality of the second playback existence/non-existence information L2 generated in accordance with the edited edit playback order, the video camera 1 can reliably record the second playback existence/non-existence information L2, because the area for recording the second playback existence/non-existence information L2 is reserved in advance. Thus, it is possible to ensure a state allowing to edit the record data recorded on an optical disc.

Furthermore, the video camera 1 records, on the optical disc, a plurality of record data RD, a plurality of first playback existence/non-existence information L1, the first reference-order definition information LC1, and then additionally records the second reference-order definition information LC2 in the predetermined fourth recording area R4 used for recording the first reference-order definition information LC1. Thus, when the video camera 1 edits the playback order of a plurality of the record data RD, and records a plurality of the second reference-order definition information LC2 generated in accordance with the edited edit playback order, the video camera 1 can record the second reference-order definition information LC2 without using additional recording area. Accordingly, the video camera 1 can use the recording area of the optical disc effectively.

Furthermore, the video camera 1 records, on an optical disc on which a plurality of record data RD are recorded, a plurality of first playback existence/non-existence information L1, the first reference-order definition information LC1, a plurality of second playback existence/non-existence information L2, and the second reference-order definition information LC2. After that, the video camera 1 finally records again the data management information DK generated on the basis of the second reference-order definition information LC2 on the optical disc. Thus, when the video camera 1 performs the finalization processing on the optical disc, the video camera 1 can appropriately reflect the edit result of the playback order to the record data RD in an intermediate state onto the optical disc in a finalization state. Thus, the video camera 1 can play back the record data in accordance with the edited playback order in the finalization state.

In this regard, in the above-described embodiment, a description has been given of an embodiment of the present invention of the case where a program stream generated by capturing a moving image of an object is recorded on an optical disc as record data. However, the present invention is not limited to this, and may be widely applied to the case of the other record data, such as sound data, image data, text data, etc.

Also, in the above-described embodiment, a description has been given of an embodiment of the present invention of the case where record data is recorded onto a DVD-RW in accordance with a DVD video standard. However, the present invention is not limited to this, and may be widely applied to the case of the other rewritable recording medium, such as a DVD-RAM (Random Access Memory), a CD (Compact Disc), a Blue-ray Disk (trademark), a semiconductor memory, a hard disk, etc., as long as a recording medium on which record data is recorded in accordance with the same standard as the DVD video standard. Also, in the case of a non-rewritable CD-R (Recordable), DVD-R (Recordable), etc., if a plurality of second recording areas R2 are provided for recording the first reference-order definition information LC1 as intermediate-state management information, new first reference-order definition information LC1 is generated each time when the record data RD is recorded onto the optical disc, and is recorded into the second recording area R2, and the newest first reference-order definition information LC1 is used among a plurality of the first reference-order definition information LC1 recorded on the optical disc, it is possible to obtain the same advantages as those of the above-described embodiment.

Furthermore, in the above-described embodiment, a description has been given of an embodiment of the present invention of the case where the record data RD for each of the predetermined continuous units specified by the plurality of continuous unit-playback specification information CL is used for unit data. However, the present invention is not limited to this, and the record data RD for each predetermined unit specified by the unit-playback specification information CL may be used for unit data.

Furthermore, in the above-described embodiment, a description has been given of an embodiment of the present invention of the case where the sixth recording area R6 and the seventh recording area R7 for recording the second playback existence/non-existence information L2 in accordance with the edit playback order of the record data RD are reserved. However, in addition to this, a recording area for recording the other data may be reserved, for example such as the case of reserving a recording area so as to allow additionally recording effect data to the record data RD afterward. In this case, the video camera 1 can effectively use the intermediate sate of an optical disc.

Furthermore, in the above-described embodiment, a description has been given of the case where a data recording apparatus according to the present invention is applied to the video camera 1 described in FIGS. 1 to 8. However, the present invention is not limited to this, and can be widely applied to various kinds of other data recording apparatuses, such as a cellular phone with a camera, a digital still camera, a personal computer, a DVD recorder, a hard disk recorder, etc.

Furthermore, in the above-described embodiment, a description has been given of the case where the above-described recording/playback section 8 is used as the recording section for recording a plurality of recording data onto a recording medium in FIGS. 1 to 8. However, the present invention is not limited to this, and an external recording apparatus, etc., may be used as long as the apparatus can record and play back record data onto a recording medium.

Furthermore, in the above-described embodiment, a description has been given of the case where the central processing unit 3 described above in FIGS. 1 to 8 is used as the first playback existence/non-existence information generation section generating a plurality of pieces of the first playback existence/non-existence information indicating the playback existence/non-existence of each of the plurality of record data recorded on the recording medium by the recording section. However, the present invention is not limited to this, and can be widely applied to the other various kinds of playback existence/non-existence information generation sections, such as a first playback existence/non-existence information generation circuit, etc., generating a plurality of pieces of the first playback existence/non-existence information indicating the playback existence/non-existence of each of the plurality of record data recorded on the recording medium by the recording section.

Furthermore, in the above-described embodiment, a description has been given of the case where the central processing unit 3 described above in FIGS. 1 to 8 is used as the first reference-order definition information generation section generating first reference-order definition information defining a plurality of pieces of the first playback existence/non-existence information. However, the present invention is not limited to this, and can be widely applied to various kinds of other first reference-order definition information generation sections, such as a first reference-order definition information generation circuit, etc., generating a plurality of pieces of the first reference-order definition information defining the reference order of the plurality of pieces of the first reference-order definition information.

Furthermore, in the above-described embodiment, a description has been given of the case where the central processing unit 3 described above in FIGS. 1 to 8 is used as the second playback existence/non-existence information generation section generating a plurality of pieces of the second playback existence/non-existence information indicating the playback existence/non-existence of each of the plurality of record data recorded on the recording medium by the recording section. However, the present invention is not limited to this, and can be widely applied to various kinds of other playback existence/non-existence information generation sections, such as a second playback existence/non-existence information generation circuit, etc., generating a plurality of pieces of the second playback existence/non-existence information indicating the playback existence/non-existence of each of the plurality of record data recorded on the recording medium by the recording section.

Furthermore, in the above-described embodiment, a description has been given of the case where the central processing unit 3 described above in FIGS. 1 to 8 is used as the second reference-order definition information generation section generating first reference-order definition information defining a plurality of pieces of the second playback existence/non-existence information. However, the present invention is not limited to this, and can be widely applied to various kinds of other second reference-order definition information generation sections, such as a second reference-order definition information generation circuit, etc., generating a plurality of pieces of the second reference-order definition information defining the reference order of the plurality of pieces of the second reference-order definition information.

Furthermore, in the above-described embodiment, a description has been given of the case where the central processing unit 3 described above in FIGS. 1 to 8 is used as a control section controlling the recording section such that, from the time that the record data has been recorded onto the recording medium to the time that common data management information among apparatuses is finally recorded onto the recording medium, in order to allow another data-playback apparatus to play back the record data from the recording medium, control is performed such that a plurality of pieces of the first playback existence/non-existence information and the first reference-order definition information are recorded, and then a plurality of pieces of the second playback existence/non-existence information and the second reference-order definition information are recorded. However, the present invention is not limited to this, and can be widely applied to various kinds of other control sections controlling the recording sections such that, from the time that the record data has been recorded onto the recording medium to the time that common data management information among apparatuses is finally recorded onto the recording medium, in order to allow another data-playback apparatus to playback the record data from the recording medium, control is performed such that a plurality of pieces of the first playback existence/non-existence information and the first reference-order definition information are recorded, and then a plurality of pieces of the second playback existence/non-existence information and the second reference-order definition information are recorded.

It should be understood by those skilled in the art that various modifications, combinations, sub-combinations and alterations may occur depending on design requirements and other factors insofar as they are within the scope of the appended claims or the equivalents thereof.

1. A data recording apparatus comprising:
a recording section for recording a plurality of record data onto a recording medium;
a first playback existence/non-existence information generation section for generating a plurality of pieces of first playback existence/non-existence information indicating playback existence/non-existence of a plurality of the record data, respectively, recorded on the recording medium by the recording section;
a first reference-order definition information generation section for generating first reference-order definition information defining reference order of a plurality of pieces of the first playback existence/non-existence information;
a second playback existence/non-existence information generation section for generating a plurality of pieces of second playback existence/non-existence information indicating playback existence/non-existence of a plurality of the record data, respectively, recorded on the recording medium by the recording section;
a second reference-order definition information generation section for generating second reference-order definition information defining reference order of a plurality of pieces of the second playback existence/non-existence information; and
from the time that the record data has been recorded onto the recording medium to the time that common data management information among apparatuses is finally recorded onto the recording medium in order to allow another data-playback apparatus to play back the record data from the recording medium, a control section for controlling the recording section so as to record a plurality of pieces of the first playback existence/non-existence information and the first reference-order definition information, and then to record a plurality of pieces of the second playback existence/non-existence information and the second reference-order definition information.

2. The data recording apparatus according to claim 1, wherein the control section controls the recording section such that in a state of having reserved a plurality of playback existence/non-existence information recording areas in order to record a plurality of pieces of second playback existence/non-existence information onto the recording medium, a plurality of pieces of first playback existence/non-existence information and the first reference-order definition information are recorded together with a plurality of the record data, and then a plurality of pieces of the second playback existence/non-existence information is recorded into the plurality of playback existence/non-existence information recording areas.

3. The data recording apparatus according to claim 2, wherein the control section controls the recording section such that a plurality of pieces of the first playback existence/non-existence information and the first reference-order definition information are recorded together with a plurality of the record data, and then the second playback existence/non-existence information is additionally recorded into predetermined reference-order definition information recording area used for recording the first reference-order definition information.

4. The data recording apparatus according to claim 1, wherein the control section controls the recording section such that a plurality of pieces of the first playback existence/non-existence information and the first reference-order definition information, a plurality of pieces of the second playback existence/non-existence information, and the second reference-order definition information are recorded onto the recording medium holding a plurality of the record data, and then the second reference-order definition information is finally recorded again onto the recording medium as the data management information.

5. The data recording apparatus according to claim 1, wherein the control section records the record data onto the recording medium as a plurality of unit data;
the first playback existence/non-existence information generation section generates the first playback existence/non-existence information indicating playback existence/non-existence of each of the plurality of the unit data constituting the record data for each of the record data; and
the second playback existence/non-existence information generation section generates the second playback existence/non-existence information indicating playback existence/non-existence of each of the plurality of the unit data constituting the record data for each of the record data.

6. A method of recording data, comprising:
recording a plurality of record data onto a recording medium;
recording first information, including, from the time that the record data has been recorded onto the recording medium to the time that common data management information among apparatuses is finally recorded onto the recording medium, in order to allow another data-playback apparatus to play back the record data from the recording medium, generating a plurality of pieces of first playback existence/non-existence information indicating playback existence/non-existence of a plurality of the record data, respectively, at the same time, generating first reference-order definition information defining reference order of the plurality of pieces of the first playback existence/non-existence information, and recording the first playback existence/non-existence information and the first reference-order definition information onto the recording medium; and
recording second information, including, from the time that the record data is recorded onto the recording medium to the time that the data management information is finally recorded, recording the first playback existence/non-existence information and the first playback existence/non-existence information onto the recording medium, and then generating a plurality of pieces of second playback existence/non-existence information indicating playback existence/non-existence of a plurality of the record data, respectively, at the same time, generating second reference-order definition information defining reference order of a plurality of pieces of the second playback existence/non-existence information, and recording the second playback existence/non-existence information and the second reference-order definition information onto the recording medium.

7. A data recording program for causing a computer to perform the processing, comprising:
recording a plurality of record data onto a recording medium;
recording first information, including, from the time that the record data has been recorded onto the recording medium to the time that common data management information among apparatuses is finally recorded onto the recording medium, in order to allow another data-playback apparatus to play back the record data from the recording medium, generating a plurality of pieces of first playback existence/non-existence information indicating playback existence/non-existence of a plurality of the record data, respectively, at the same time, generating first reference-order definition information defining reference order of a plurality of pieces of the first playback existence/non-existence information, and recording the first playback existence/non-existence information and the first reference-order definition information onto the recording medium; and
recording second information, including, from the time that the record data is recorded onto the recording medium to the time that the data management information is finally recorded, recording the first playback existence/non-existence information and the first playback existence/non-existence information onto the recording medium, and then generating a plurality of pieces of second playback existence/non-existence information indicating playback existence/non-existence of a plurality of the record data, respectively, at the same time, generating second reference-order definition information defining reference order of a plurality of pieces of the second playback existence/non-existence information, and recording the second playback existence/non-existence information and the second reference-order definition information onto the recording medium.
